(19) United States
(12) Patent Application Publication
(10) Pub. No.: US 2010/0102992 A1
(43) Pub. Date: Apr. 29, 2010

(54) SYSTEMS AND METHODS FOR REMOTE MONITORING OF WEATHER

(75) Inventors: Alan Cornett, Andover, MN (US); Craig Kevin Madden, Washington, DC (US); David W. Meyers, Brooklyn Park, MN (US); Robert Charles Becker, Eden Prairie, MN (US); David Todd Spoor, Eden Prairie, MN (US)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 12/259,875

(22) Filed: Oct. 28, 2008

(51) Int. Cl. G01C 23/00

(52) U.S. Cl. 340/971

(57) ABSTRACT

Systems and methods are operable to capture images of weather along a portion of a flight path of an aircraft, and are operable to wirelessly communicate information corresponding to the captured images to the aircraft. An exemplary embodiment has at least one camera pointed in a direction corresponding to a portion of the flight path of the aircraft and configured to capture images of weather in proximity to the portion of the flight path, and has a transceiver configured to wirelessly communicate images captured by the at least one camera.

### BACKGROUND OF THE INVENTION

Aircraft travelling along a flight path typically traverse relatively long distances. The aircraft crew may visually discern weather relatively close to the aircraft, and various onboard detection devices, such as a radar system, may provide information about weather conditions beyond the visual range of the aircraft crew. However, some segments of the flight path have no timely weather information available at all. Information about weather conditions along such remote segments of the flight path beyond the radar range of the aircraft may be available from other sources, such as ground stations and/or other aircraft. For example, other aircraft may provide weather information in the form of pilot reports (PIREPS). However, supplemental weather information from other sources may not be available for some segments of the flight path.

For example, a combat mission performed by military aircraft is preferably performed during ideal weather conditions, or at least during favorable weather conditions. When the weather is unfavorable to the extent that successful performance of the mission is at risk, military commanders may choose to cancel or delay the mission. In this situation, it is appreciated that the quality of weather information over the target area, or along some flight path segments leading to the target area, may be very poor or may not be available. Of key interest in such military applications is the aircraft crew's visibility about the target area, or along the flight path leading to the target area.

In some instances, covert ground-based personnel may be inserted near the target area, or along the remote flight path segments leading to the target area, to obtain weather information. The covert personnel may provide ground-based observations describing their perceptions of the visibility of the local area. However, it is appreciated that using ground-based covert personnel for gathering weather information may be hazardous to the pilot because the information is of verbal content which is subjective. Additionally, personnel may not be available to insert into the remote locations.

Weather information for the remote flight path segments may be useful in other situations. For example, aircraft often drop firefighters or fire retardant chemicals when fighting a fire. Prior to takeoff, the aircraft crews would benefit from knowledge of weather conditions in the vicinity of the fire, which is often a remote location where no sources of weather information are available.

As another example, weather information over large bodies of water, such as an ocean or a sea, may not be available or may be stale. In such situations, PIREPS from other aircraft travelling over the ocean may provide relevant and timely weather information. However, their flight paths may not coincide with the flight path of the aircraft desiring weather information, or the PIREPS information may have been issued several hours earlier and may not be accurate when the aircraft is in the vicinity pertaining to the weather information described in the earlier issued PIREPS.

Accordingly, it is desirable to obtain weather information for remote segments of a flight path where such information is not readily available on a real time, or near real time, basis. More particularly, real time, or near real time, access to information pertaining to visibility conditions over a remote flight path segment is desirable.

### SUMMARY OF THE INVENTION

Systems and methods are operable to capture images of weather along a portion of a flight path of an aircraft, and are operable to wirelessly communicate information corresponding to the captured images to the aircraft. An exemplary embodiment has at least one camera pointed in a direction corresponding to a portion of the flight path of the aircraft and configured to capture images of weather in proximity to the portion of the flight path, and has a transceiver configured to wirelessly communicate images captured by the at least one camera.

### BRIEF DESCRIPTION OF THE DRAWINGS

Preferred and alternative embodiments are described in detail below with reference to the following drawings:

FIG. 1 is a conceptual illustration of a flight path monitored by an embodiment of the flight path segment monitoring system;

FIG. 2 is a block diagram of an embodiment of the flight path segment monitoring system; and

FIG. 3 is a conceptual illustration of a display that is displaying an image of weather received from an embodiment of the flight path segment monitoring system.

### DETAILED DESCRIPTION OF THE PREFERRED EMBODIMENT

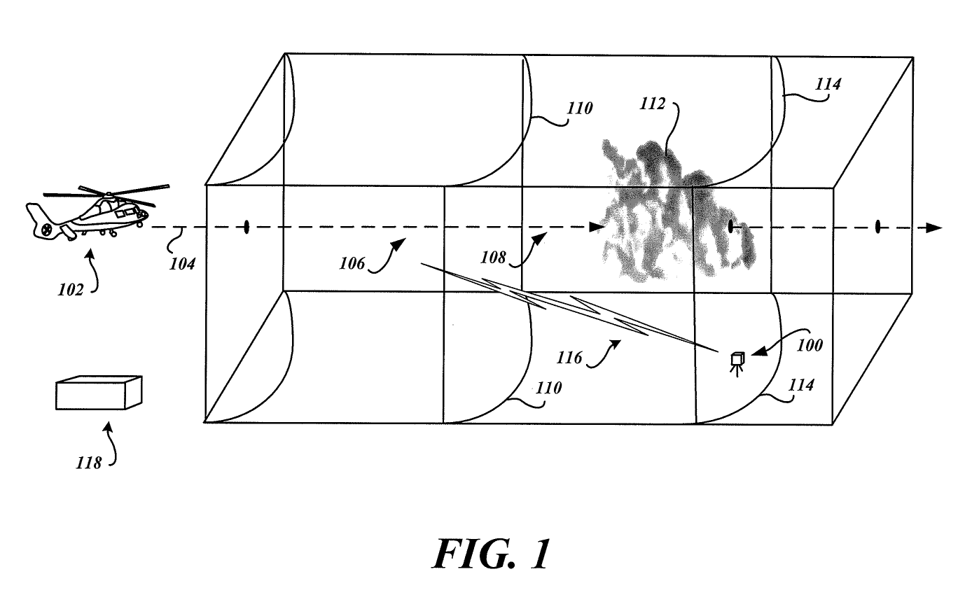

FIG. 1 is a conceptual illustration of a flight path monitored by an embodiment of the flight path segment monitoring system 100. An aircraft 102, illustrated as a helicopter, is illustrated as travelling along a planned flight path 104 having a discernable flight path segment 106 and a remote flight path segment 108.

The discernable flight path segment 106 extends to a range 110 where the aircraft crew is able to meaningfully discern visible weather phenomena or obstructions such as a mountain range. The discernable flight path segment 106 may be within the visual line-of-sight distance of the aircraft crew, and/or within the range of onboard detection devices such as a radar system.

Beyond the range 110, the aircraft crew is not able to visually discern weather phenomena or detect the weather phenomena with their onboard devices. For example, a relatively large cloud formation 112 is illustrated at a range 114 that is well beyond the range 110. Since the location of the cloud formation 112 is well beyond the discernable range of the aircraft crew, information pertaining to the cloud formation 112 must be provided from other sources.

An embodiment of the flight path segment monitoring system 100 is illustrated as being in proximity to the remote flight path segment 108. Cameras on the flight path segment monitoring system 100 view the remote flight path segment 108. Embodiments of the flight path segment monitoring system 100 generate images of the cloud formation 112. Then, the flight path segment monitoring system 100 communicates weather information, which includes the captured image information showing the cloud formation 112, via a wireless signal 116, to the aircraft 102. Accordingly, the aircraft crew is able to view the images showing the cloud formation 112. If the images indicate that visibility in the vicinity of the cloud formation 112 is acceptable, the aircraft crew may choose to traverse the remote flight path segment 108. On the other hand, if the visibility is unacceptable, the aircraft crew may choose to return to their base (or not take off), or may choose to make changes to the planned flight path 104.

Alternatively, or additionally, embodiments of the flight path segment monitoring system 100 may communicate the image information to another location, such as a base station 118. The base station 118 may relay the image information to the aircraft 102, or provide other suitable weather information to the aircraft 102. In some situations, such as before the aircraft 102 has taken off from an air field, the base station 118 may indicate that the visibility in the region about the flight path segment monitoring system 100 is acceptable such that the aircraft 102 is advised to take off and/or proceed. If the visibility in the region about the flight path segment monitoring system 100 is unacceptable, the base station 118 may advise the aircraft 102 to not to take off and/or proceed along the remote flight path segment 108.

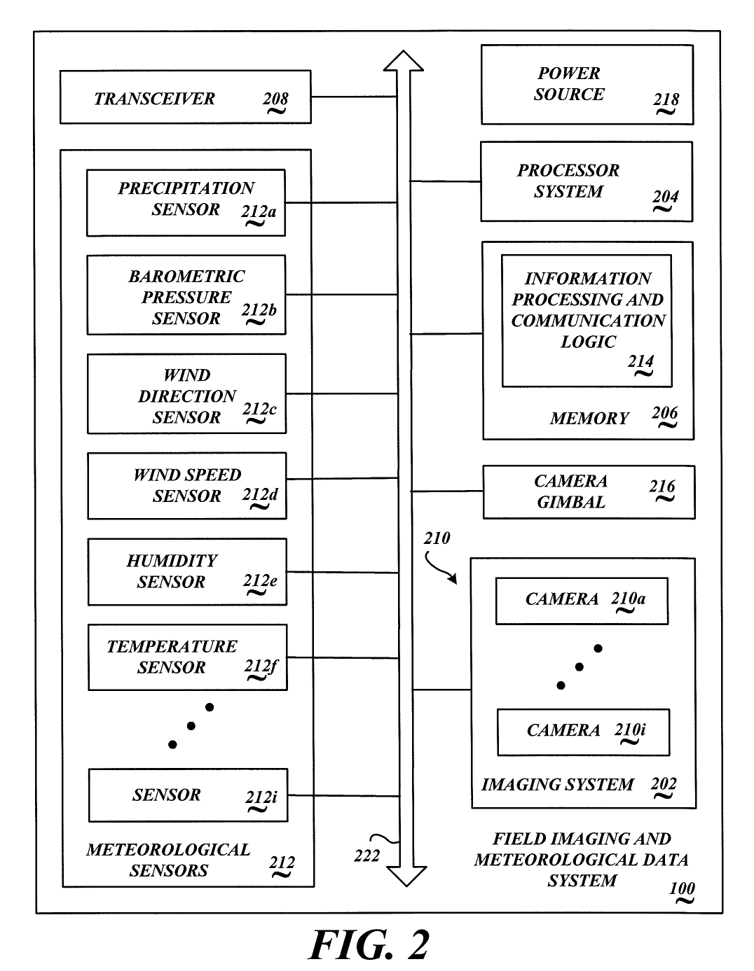

FIG. 2 is a block diagram of an embodiment of the flight path segment monitoring system 100. Embodiments include an imaging system 202, a processor system 204, a memory 206, a transceiver 208. Imaging system 202 includes one or more cameras 210. Some embodiments may include a meteorological sensors 212 with a plurality of sensors 212a-212i therein.

One or more cameras 210 residing in the imaging system 202 capture images of weather in the vicinity of the flight path segment monitoring system 100. The information processing and communication logic 214 receives image information from one or more of the cameras 210, formats the received image information into information that is suitable for transmission using the wireless signal 116 (FIG. 1). Transceiver 208 broadcasts the image information that has been processed by the information processing and communication logic 214.

The cameras 210 may be still image cameras and/or video image cameras depending upon the specific application for which the flight path segment monitoring system 100 has been designed. For example, if power conservation is a design consideration, the cameras 210a-210i may be still image cameras. Similarly, if communication bandwidth is a design consideration, the cameras 210a-210i may be still image cameras in situations where bandwidth may be limited, or the cameras 210a-210i may be video cameras where bandwidth is not a limitation. In some applications, one or more of the cameras 210 may be infrared sensitive cameras. Additionally, or alternatively, one or more of the cameras 210 may be night vision enhanced to provide night vision images.

In some applications, a particular direction of interest from the location of the flight path segment monitoring system 100 may be important. If a single direction is of interest, a single camera 210 may be used. For example, if an image of weather directly above the flight path segment monitoring system 100 is of interest, a single camera 210 pointed directly upward may be used. If a range or plurality of directions is of interest, a plurality of cameras 210 may be used to capture images over the range or plurality of directions of interest. For example, if images of weather are desired for the four compass directions, four cameras 210 may be used. If a range of azimuth along a particular direction is of interest, the camera 210 may be tilted, a plurality of cameras 210 may be used along the direction and oriented at different azimuths, and/or a specialized lens may be used to optically collect image information in the directions and/or azimuths of interest.

In some embodiments, one or more of the cameras 210 may be mounted on an optional camera gimbal 216 that is configured to point one or more cameras 210 mounted thereon in a direction of interest. For example, the direction of interest may be predefined. Alternatively, or additionally, a received polling or interrogation signal may include information identifying one or more directions of interest, wherein the gimbal 216 is actuated to point the camera 210 in the direction(s) of interest.

Additionally, or alternatively, the camera 210 may be moved along some predefined path of movement. For example, the camera 210 mounted on the camera gimbal 216 may be panned and/or tilted to capture images over a range of directions and/or azimuths of interest. Some embodiments are operable to receive instructions from a remote source, such as the aircraft 102 and/or the base station 118 (FIG. 1). In such embodiments, the camera gimbal 216 is configured to point the camera 210 in an instructed direction.

Some embodiments of the flight path segment monitoring system 100 may include one or more meteorological sensors 212 which provides supplemental weather information. Nonlimiting examples of the meteorological sensors 212 include a precipitation sensor 212a that is configured to detect amounts of precipitation, a barometric pressure sensor 212b that is configured to detect barometric pressure, a wind direction sensor 212c that is configured to detect wind direction, a wind speed sensor 212d that is configured to detect wind speed, a humidity sensor 212e that is configured to detect humidity, and/or a temperature sensor 212f that is configured to detect temperature. Information from these meteorological sensors 212 may be included with the image information that is broadcast from the flight path segment monitoring system 100. Any suitable meteorological sensor 212 may be used.

Alternatively, or additionally, the weather information from the meteorological sensors 212 may be provided in response to a polling or interrogator signal received from the requesting aircraft 102 (FIG. 1). In one embodiment, the received polling or interrogator signal included a request for information from one or more of the sensors 212. In another embodiment, the information is sent from all available sensors 212 in response to the received polling or interrogator signal.

The flight path segment monitoring system 100 is a portable device that may be readily located in a remote location. Embodiments may be deployed on land or water. Some embodiments may be deployed directly from an aircraft or other vehicle. Alternatively, or additionally, some embodiments may be deployed by field personnel. Accordingly, embodiments may come in a variety of sizes, weights, and/or configurations depending upon the particular deployment location and/or surveillance application involved. For example, an embodiment deployed by a person may be relatively light weight and small, with only a single fixed-mount camera 210. An embodiment located at a remote base or other installation may be relatively larger and heavier, with a plurality of cameras 210, since the flight path segment monitoring system 100 could be delivered to the deployment site by a vehicle, such as a truck, a jeep, an aircraft, a helicopter, a boat, etc.

Power may be an issue that determines the configuration of the flight path segment monitoring system 100. Power requirements may affect the source of power, the effective field life of the flight path segment monitoring system 100, the number and/or type of cameras, and the manner in which camera image information is transmitted from the flight path segment monitoring system 100.

For example, the power source 218 may be a battery with a limited useful amount of power. Accordingly, the number and/or size of the camera(s) 210 may be selected based upon the desired useful field life of the flight path segment monitoring system 100. Further, the gimbal 216 (having moving parts which require power for operation) may be omitted. Thus, the field personnel deploying the flight path segment monitoring system 100 would manually point the camera(s) 210 in a direction(s) of interest. Also, the effective broadcast range of the transceiver 208 may be less when the power source 218 is a battery.

Since battery life of the power source 218 is limited, the flight path segment monitoring system 100 may be operable to respond only after receiving a polling or an interrogation signal. For example, the aircraft 102 may communicate the polling or interrogation signal to the flight path segment monitoring system 100 such that the camera image information, and any available or selected meteorological information that is available from the meteorological sensors 212, is broadcasted from the transceiver 208. Further, the camera(s) 210 may be still image cameras to reduce the amount of camera information that is transmitted.

In other applications, the flight path segment monitoring system 100 may periodically transmit the information to conserve power. For example, the flight path segment monitoring system 100 may go into a “sleep” mode of operation, then wake up at a user defined interval to transmit weather and image data. Further, weather and image data may be collected from time to time by the flight path segment monitoring system 100 and saved into the memory 206. Then, the weather information spanning a time period of interest may be broadcast.

On the other hand, the power source 218 of the flight path segment monitoring system 100 may be an interface or the like that receives power from another source. For example, the flight path segment monitoring system 100 may be deployed at a location that has an independent power source. Accordingly, a larger number of the cameras 210 may be used since the useful field life of the flight path segment monitoring system 100 is not limited by power requirements. Further, the gimbal 216 may be used to point the camera(s) 210 in a direction of interest.

In some embodiments, the power source 218 may include a source of power, such as a wind turbine, a fuel cell, a solar panel, or other power source. In an exemplary embodiment, the source of power supplements the battery of the power source 218 using a trickle charger to recharge the battery. Thus, the remote flight path segment 108 may be deployed for a relatively longer useful field life.

Security of the remote flight path segment 108 may be another design consideration. In covert applications, encryption may be used to ensure that only qualified devices are able to receive and process the transmitted image information. Security may also be provided in embodiments which are configured to respond only to authorized polling or interrogation requests. Further, a password or encryption key, or the like, may be used to ensure that the remote flight path segment 108 responds to only those qualified receiver devices issuing the polling or interrogation request. Also, since it is expected that a polling or interrogation request would only be received at specific times of interest, the remote flight path segment 108 would not be broadcasting at other times. Accordingly, the broadcast wireless signal 116 could not be easily used to locate the remote flight path segment 108 by parties who may wish to deactivate the remote flight path segment 108.

The imaging system 202, the processor system 204, the memory 206, the transceiver 208, the cameras 210, the meteorological sensors 212, are communicatively coupled to communication bus 222, thereby providing connectivity between the above-described components. In alternative embodiments, the above-described components may be communicatively coupled to each other in a different manner than illustrated in FIG. 2. For example, one or more of the above-described components may be directly coupled to the processor system 204 or may be coupled to the processor system 204 via intermediary components (not shown).

In the various embodiments, transceiver 208 is a communication device or system configured to receive and transmit radio frequency (RF) signals. It is appreciated that any suitable transceiver device or system may be used, and that the transceiver 208 may have a variety of components therein which are not described or illustrated herein for brevity. For example, but not limited to, the transceiver 208 may include as components a transmitter and an optional receiver device or system. Further, such components themselves may be separate devices or systems.

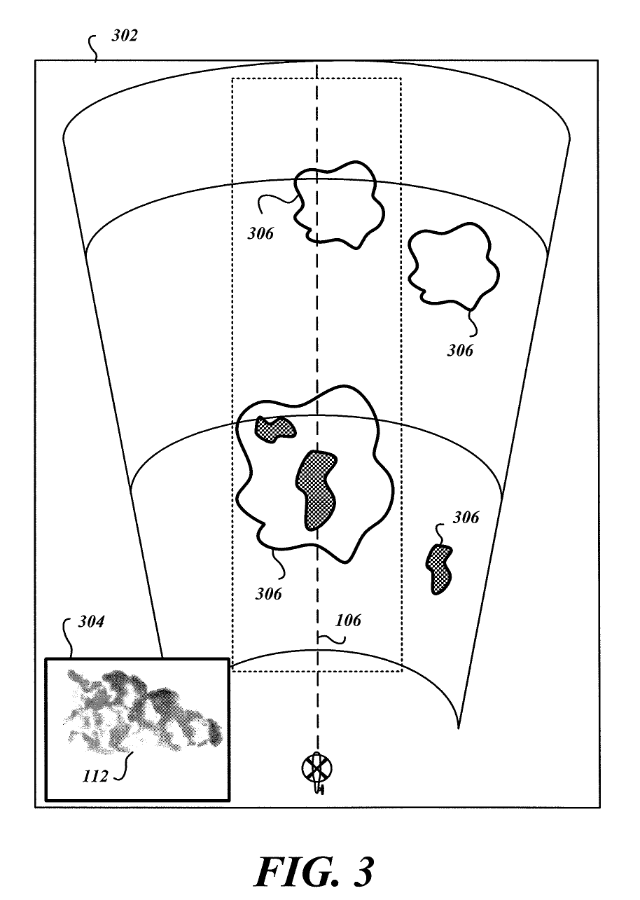

FIG. 3 is a conceptual illustration of a display 304 that is displaying an image 304 of weather received from an embodiment of the flight path segment monitoring system 100. Here, the image 304 is illustrated as a captured image of the cloud formation 112 (FIG. 1). The image 304 is displayed using a picture-in-a-picture (PIP) format on a multi-purpose display 302. For example, the display 302 is illustrated as displaying radar information indicating a plurality of storms 306 in the vicinity of the aircraft 102 that is within the detection range of its on-board radar system. In other embodiments, the display 304 may be a dedicated display device for displaying images received from the flight path segment monitoring system 100.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for communicating remotely captured images of weather to an aircraft, the method comprising:
capturing an image of the weather with a camera that is pointed at a portion of a flight path of the aircraft; and
wirelessly communicating information corresponding to the remotely captured image to the aircraft.

2. The method of claim 1, wherein the weather is in proximity to a remote portion of a planned flight path of the aircraft that is beyond a discernable range of a crew of the aircraft.

3. The method of claim 2, wherein the weather is in proximity to the remote portion of the planned flight path of the aircraft that is beyond a detection range of a radar of the aircraft.

4. The method of claim 1, further comprising:
receiving a signal; and
wirelessly communicating information corresponding to the remotely captured image to the aircraft in response to receiving the signal.

5. The method of claim 4, wherein the received signal comprises information identifying a direction of interest, the method further comprising:
actuating a gimbal to point the camera in the direction of interest.

6. The method of claim 1, further comprising:
acquiring meteorological information with at least one meteorological sensor;
combining the acquired meteorological information with the remotely captured image information; and
wirelessly communicating the information corresponding to the remotely captured image and the acquired meteorological information to the aircraft.

7. The method of claim 6, wherein the meteorological sensor comprises at least one selected from a group consisting of a precipitation sensor configured to detect amounts of precipitation, a barometric pressure sensor configured to detect barometric pressure, a wind direction sensor configured to detect wind direction, a wind speed sensor configured to detect wind speed, a humidity sensor configured to detect humidity, and a temperature sensor configured to detect temperature.

8. The method of claim 1, wherein capturing the remote image of the weather with the camera further comprises:
capturing an infrared image of the weather with an infrared sensitive camera.

9. The method of claim 1, wherein capturing the remote image of the weather with the camera further comprises:
capturing an image of the weather at night with a night vision enhanced camera.

10. The method of claim 1, wherein wirelessly communicating information corresponding to the remotely captured image to the aircraft further comprises:
wirelessly communicating information corresponding to the remotely captured image to a base station, therein the wirelessly communicated information is then communicated to the aircraft.

11. The method of claim 1, further comprising:
actuating a gimbal to point the camera in a direction of interest.

12. A weather imaging system for communicating remotely captured images of weather to an aircraft, comprising:
at least one camera pointed in a direction corresponding to a portion of a flight path of the aircraft and configured to capture images of weather in proximity to the portion of the flight path; and
a transceiver configured to wirelessly communicate images captured by the at least one camera.

13. The weather imaging system of claim 12, further comprising:
at least one meteorological sensor configured to acquire meteorological information, wherein the acquired meteorological information is combined with the captured image information.

14. The weather imaging system of claim 13, wherein the meteorological sensor comprises at least one selected from a group consisting of a precipitation sensor configured to detect amounts of precipitation, a barometric pressure sensor configured to detect barometric pressure, a wind direction sensor configured to detect wind direction, a wind speed sensor configured to detect wind speed, a humidity sensor configured to detect humidity, and a temperature sensor configured to detect temperature.

15. The weather imaging system of claim 12, further comprising:
gimbal configured to move the at least one camera in a predefined direction of interest.

16. The weather imaging system of claim 12, wherein the transceiver is configured to receive a signal from the aircraft that specifies a direction of interest, and further comprising:
a gimbal configured to move the at least one camera in the direction of interest.

17. The weather imaging system of claim 12, wherein the transceiver is configured to receive a signal from the aircraft, and wherein the transceiver communicates the captured image information to the aircraft in response to receiving the signal.

18. A system for communicating remotely captured images of weather to an aircraft, the method comprising:
means for capturing an image of the weather with a camera that is pointed at a portion of a flight path of the aircraft;
means for processing the captured image of the weather into information configured for communication in a wireless format; and
means for wirelessly communicating the processed information to the aircraft.

19. The system of claim 18, wherein the means for wirelessly communicating is configured to receive a signal from the aircraft, and is configured to wirelessly communicate the information corresponding to the remotely captured image to the aircraft in response to receiving the signal.

20. The system of claim 18, further comprising:
means for pointing the means for capturing in a direction of interest.
